(19) United States
(12) Patent Application Publication
(10) Pub. No.: US 2016/0379279 A1
(43) Pub. Date: Dec. 29, 2016

(54) SYSTEM AND METHOD FOR REAL-TIME AUTOMATED FORMATTING OF ADVERTISING CONTENT IN EMAIL PUBLICATIONS

(71) Applicant: Gold Lasso, Inc., Gaithersburg, MD (US)

(72) Inventors: Elie Ashery, Boyds, MD (US); Dilpreet Singh, Boyds, MD (US); Michael Weisel, North Potomac, MD (US)

(21) Appl. No.: 15/153,454

(22) Filed: May 12, 2016

Related U.S. Application Data
(60) Provisional application No. 62/184,202, filed on Jun. 24, 2015.

(51) Int. Cl. G06Q 30/02

(52) U.S. Cl. CPC G06Q 30/0276; G06Q 30/0277

(57) ABSTRACT

Disclosed are systems and methods for providing customized advertisements in electronic publications distributed by email, which advertisements have a look and feel matching the look and feel of non-advertisement content of the email electronic publication. The invention addresses the way in which customized electronic advertisements appear in electronic publications, and more particularly computer-implemented methods by which custom-selected electronic advertising data is reformatted in real-time for integration with an email electronic publication and displayed with a look and feel that matches the look and feel of the non-advertising content of the email electronic publication.

### CROSS REFERENCE TO RELATED APPLICATION

This application is based upon and claims benefit of copending U.S. Provisional Patent Application Ser. No. 62/184,202 entitled “SYSTEM AND METHOD FOR REAL-TIME AUTOMATED FORMATTING OF ADVERTISING CONTENT IN EMAIL PUBLICATIONS,” filed with the United States Patent and Trademark Office on Jun. 24, 2015 by the inventors herein, the specification of which is incorporated herein by reference.

### FIELD OF THE INVENTION

This invention relates to systems and methods for providing customized advertisements in electronic publications, and more particularly to systems and methods for providing real time customized advertisements having a look-and-feel that matches non-advertisement content in an electronic publication that is distributed by email.

### BACKGROUND OF THE INVENTION

Many publishers provide articles, alerts, newsletters, and other publications to their subscribers in electronic form, whether by way of a website, an email sent directly to a subscriber's email inbox, through social media websites, and the like. Wide use of the Internet by both individuals and corporate entities maximize the ability of publishers to reach their audiences through use of such modern electronic distribution mechanisms.

In order to subsidize the costs associated with the production and distribution of such electronic publications, many publishers rely on advertisers that will pay the publisher an amount in exchange for incorporating their advertising content in their publications. Incorporation of advertisements in online publications has been in use for some time, and has seen improvements including providing targeted advertisements that are selected for a particular reader. For instance, specific advertising content may be selected for a particular reader based on geography matching of the reader's physical location (which may, by way of non-limiting example, be determined by their IP address) with advertisements for nearby businesses, or through contextual advertisement selection based on a reader's age, sex, general interests, or other factors that might be reflected in demographic records maintained by the publisher or another party, or in a number of other automated advertisement-matching technologies that are known to those skilled in the art. However, both publishers and advertisers struggle with getting the readers to actually engage with such advertisements so as to allow the advertisers to maximize the return on their advertising investment.

One method for increasing the likelihood of having a reader engage with an advertisement is to have the advertisement appear in the same format as other material in the publication. For instance, on a news website, various articles may be provided that will often include, by way of non-limiting example, an article headline, a summary or description of the subject matter of the article, and often an image that relates to the subject matter of the article. Such different elements of each story often have a common look and feel, including things such as font size, color, and style for the different portions of each article headline and summary, a common image size and placement, and a common border or window size and color, with the overall document similarly having a look and feel including spacing and alignment of different articles with respect to one another, and such other visually perceptible publication design and layout features as will be apparent to those skilled in the art. In this electronic publication environment, advertisements can be provided that have a matching look and feel to the non-advertisement material in the publication, such as the articles themselves. By formatting the advertisements with a similar look and feel to the articles of the publication, a reader that is scanning through the publication is likely to spend an equal amount of time examining an advertisement as they are an actual article from the publication, as an initial casual review would not typically allow for discrimination between the two.

While web browsers are able to integrate sophisticated programming language (e.g., JAVA, JAVASCRIPT, ADOBE FLASH, HTML code, etc.) that allows for sophisticated programming and customization of content on a website which might allow the foregoing advertisement formatting to be carried out, email does not afford the same opportunities. More particularly, the software code necessary to implement the above-described customization can be quite difficult to implement in an email message. Moreover, traditional advertisement serving technologies, such as JAVASCRIPT, are typically disabled in email clients due to security concerns. As a result, electronic publications that are distributed by email have thus far been denied the opportunity to incorporate such customized, format-matching advertisements that typical web-based publications have afforded.

Thus, there remains a need in the art for systems and methods that can provide customized advertisements in electronic publications distributed by email, and more particularly customized advertisements that have a look and feel matching the non-advertisement content of such email electronic publication.

### SUMMARY OF THE INVENTION

Disclosed are systems and methods for providing customized advertisements in electronic publications distributed by email, which advertisements have a look and feel matching the look and feel of non-advertisement content of the email electronic publication, which systems and methods avoid the disadvantages of the prior art. The invention addresses the way in which customized electronic advertisements appear in electronic publications, and more particularly computer-implemented methods by which custom-selected electronic advertising data is reformatted in real-time for integration with an email electronic publication and displayed with a look and feel that matches the look and feel of the non-advertising content of the email electronic publication.

The invention particularly addresses a need in the art for a method and apparatus for real-time reformatting of electronic advertisement data to provide a customized advertisement in an email electronic publication, which customized advertisement embodies a look and feel that matches the look and feel of the non-advertising content of such electronic publication, which in turn increases the likelihood that a reader will view and interact with such advertisement.

As used herein, the look and feel of the advertisement and of the email electronic publication refers to visually perceptible elements of the email electronic publication, and may include colors, fonts, page frames and borders, page layout, and other elements that are native to the electronic publication (e.g., original images such as a “READ MORE” button or the like), as well as such other graphic design elements as may occur to those skilled in the art.

The invention also addresses the challenge of inducing a reader of an electronic publication to engage with an advertisement in that publication that has been particularly selected for that reader in real-time, in the specific context of an email electronic publication. Here, the content, and particularly the advertising content, of the email publication is manipulated to yield the desired result of having the custom-selected advertisement match the look and feel of the remainder of the electronic publication, thus increasing the likelihood that a reader will review and engage with such advertisement. Instead of merely selecting a customized advertisement for the reader and placing the same in, for example, a banner advertisement or the like in such emailed publication, the system and method set forth herein dynamically construct, in real-time, a composite email electronic publication including a newly rendered advertisement image, which image is suitable for easy incorporation in an email message that contains the advertisement content but that presents such content in a format having a look and feel matching the look and feel of the non-advertising content of the publication.

Further, the invention addresses the Internet-centric challenge of modifying in real-time custom selected electronic advertisement content for inclusion in dynamically constructed, email electronic publications in a way that causes the advertising content to match the look and feel of the non-advertising content in the electronic publication. This challenge is addressed by creating an electronic publisher-specific advertisement template that defines the look and feel of any advertisement so that it matches the look and feel of the rest of the email electronic publication, transmitting computer software code to a publisher for embedding in their electronic publication, and when an email (or other, similarly configured electronic message) including the electronic publication is opened by a subscriber, having the embedded software code (i) select an advertisement, (ii) reformat the electronic advertising content of the advertisement using the advertisement template into a form that matches the look and feel of the non-advertising content in the electronic publication, and forming an image of the altered advertisement, and (iii) dynamically construct the electronic publication in the viewer's email reader application to display that image of the altered advertisement in the body of the electronic publication. The system and method disclosed herein thus transform the original advertisement data into an image that in turn is placed in the email electronic publication, which image is formatted with a look and feel that matches the look and feel of the non-advertising content of the electronic publication.

In accordance with certain aspects of an embodiment of the invention, a computer-implemented method is provided for presenting to a subscriber a composite email electronic publication having non-advertising data with a defined look and feel and advertising data, the method comprising: providing a computer system including a computer processor having computer executable code configured to execute an advertisement management module; creating a computer readable advertisement template defining a look and feel matching the look and feel of the non-advertising data in the email electronic publication; receiving at the advertisement management module notification from a subscriber computing device that an email message including an email electronic publication has been opened on the subscriber computing device; receiving at the advertisement management module advertisement data from an advertiser computing device; creating at the advertisement management module an electronic image including the advertisement data, wherein the electronic image is automatically formatted with a visual appearance defined by the advertisement template; and transmitting the electronic image to the subscriber computing device, wherein the transmission is configured to cause a dynamically constructed email electronic publication including an advertisement having a look and feel matching non-advertising content of the email electronic publication to be rendered in email client software on the subscriber device.

In accordance with further aspects of an embodiment of the invention, a system is provided for presenting to a subscriber a composite email electronic publication having non-advertising data with a defined look-and-feel and advertising data, comprising: a memory; a database; a computer processor coupled to the memory and the database, the processor having computer executable code configured to execute an advertisement management module, wherein the computer executable code is further configured to: create a computer readable advertisement template defining a look and feel matching the look and feel of the non-advertising data in the email electronic publication; receive at the advertisement management module notification from a subscriber computing device that an email message including an email electronic publication has been opened on the subscriber computing device; receive at the advertisement management module advertisement data from an advertiser computing device; create at the advertisement management module an electronic image including the advertisement data, wherein the electronic image is automatically formatted with a visual appearance defined by the advertisement template; and transmit the electronic image to the subscriber computing device, wherein the transmission is configured to cause a dynamically constructed email electronic publication including an advertisement having a look and feel matching non-advertising content of the email electronic publication to be rendered in email client software on the subscriber device; and a transmission device configured to transmit the electronic image to a subscriber by email.

In accordance with still further aspects of an embodiment of the invention, a non-transitory computer-readable storage medium is provided, storing instructions for causing a processor to perform a method for presenting to a subscriber a composite email electronic publication having non-advertising data with a defined look-and-feel and advertising data, the method comprising the steps performed by the processor of: executing an advertisement management module; creating a computer readable advertisement template defining a look and feel matching a look and feel of the non-advertising data in the email electronic publication; receiving at the advertisement management module notification from a subscriber computing device that an email message including an email electronic publication has been opened on the subscriber computing device; receiving at the advertisement management module advertisement data from an advertiser computing device; creating at the advertisement management module an electronic image including the advertisement data, wherein the electronic image is automatically formatted with a visual appearance defined by the advertisement template; and transmitting the electronic image to the subscriber computing device, wherein the transmission is configured to cause a dynamically constructed email electronic publication including an advertisement having a look and feel matching non-advertising content of the email electronic publication to be rendered in email client software on the subscriber device.

### BRIEF DESCRIPTION OF THE DRAWINGS

The numerous advantages of the present invention may be better understood by those skilled in the art by reference to the accompanying drawings in which:

FIG. 1 is a schematic view of an exemplary environment in which a system may be implemented for automatically formatting electronic advertising content in real time to match the look and feel of an email electronic publication in which such advertisement is to be presented, all in accordance with certain aspects of an embodiment of the invention.

FIG. 2 is a schematic view of a method for real time automated formatting of customized advertising content in email publications in accordance with certain aspects of an embodiment of the invention.

FIG. 3 is a schematic view of a method of creating an electronic publisher advertising template for a publisher in accordance with certain aspects of an embodiment of the invention.

FIG. 4 is a schematic view of a method of generating custom advertisement code, transmission of that code to a publisher device, and finalizing and storage of the publisher advertisement template in accordance with certain aspects of an embodiment of the invention.

FIG. 5a is a schematic view of a method of data exchange and processing among advertisement management module 100 and one or more advertisement servers 100 in accordance with certain aspects of an embodiment of the invention.

FIG. 5b is a schematic view of a method of selection of an advertisement after a suitable advertiser device 200 has been selected in accordance with certain aspects of an embodiment of the invention.

FIG. 5c is a schematic view of a method of processing advertisement data into an image for inclusion in an email electronic publication in accordance with certain aspects of an embodiment of the invention.

FIG. 5d is a schematic view of a method of transmitting the advertisement image to the subscriber device 220 in accordance with certain aspects of an embodiment of the invention. FIG. 6 is a schematic view of a method of processing user interaction with the advertisement image in accordance with certain aspects of an embodiment of the invention.

FIG. 7 provides exemplary representations of fully rendered, dynamically constructed, email electronic publications created and distributed using the system and methods of the invention.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed is a system and method for automatically formatting electronic advertising content in real-time to match the look and feel, or visually perceptible elements (e.g., colors, fonts, page frames and borders, page layout, links, existing publisher images, and anything else that is native to the electronic publication), of an email electronic publication in which such advertisement is to be presented, and for distributing such publication to subscribers by email so that the email electronic publication appears with an advertisement individually targeted to the subscriber and formatted to visually match the look and feel of the rest of the content of the electronic publication. For example, an email subscriber might receive daily, weekly, monthly, etc. transmissions of an email electronic publication in the form of a newsletter containing various news stories. Through the system and methods disclosed herein, electronic advertising content may be included in such email-distributed publication that is specifically targeted to the subscriber based on traditional ad-matching logic tools (e.g., demographics, historic advertisement interaction and other behaviors, etc.), but that appears in the electronic publication in a format that visually matches the look and feel of the remaining content of the electronic publication, such as (in this exemplary case) appearing as a single news story in the series of stories presented in the emailed publication, thus increasing the likelihood that the recipient will review and engage with the advertisement over traditional advertising presentations and methods. Importantly, so that such advertisement may be presented to the subscriber in their email client software, advertising data received from an advertiser is converted into a customized electronic image, which image is of a data format capable of easy presentation in the user's email client software (e.g., a JPEG file, a .PNG file, a .GIF file, and animated .GIF file, etc.), and which is incorporated into the electronic publication for presentation to the subscriber as they open the email electronic publication for viewing.

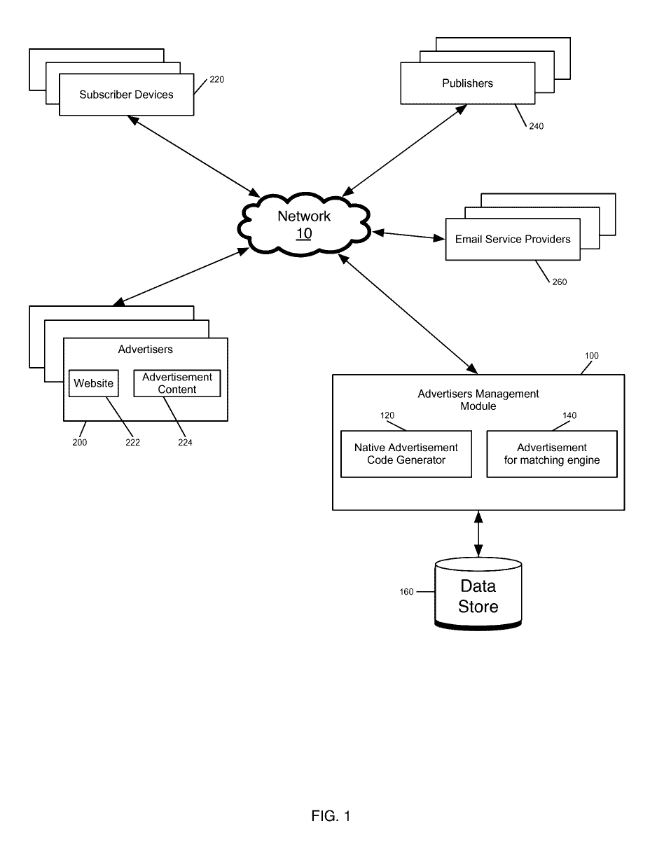

FIG. 1 is a schematic view of an exemplary environment in which a system may be implemented for automatically formatting electronic advertising content in real-time to match the look and feel of an email electronic publication in which such advertisement is to be presented, all in accordance with certain aspects of an embodiment of the invention. The exemplary environment of FIG. 1 includes a network 10, such as a wide area network such as the Internet, in electronic data communication with a computer-implemented advertisement management module 100, advertiser devices 200, subscriber devices 220, publisher devices 240, and optionally email service provider devices 260 of email service provider entities that manage email distribution of electronic publications on behalf of publishers associated with publisher devices 240. Advertisement management module 100 may communicate with each of advertiser devices 200, subscriber devices 220, publisher devices 240, and optionally email service provider devices 260 through network 10. The environment shown in FIG. 1 may include any number of advertiser devices 200, subscriber devices 220, publisher devices 240, and email service provider devices 260, all in communication with advertisement management module 100.

Each of advertiser devices 200, subscriber devices 220, publisher devices 240, and email service provider devices 260 preferably comprise an electronic device under the control of an advertiser, subscriber, publisher, or email service provider, respectively, and may comprise personal computers, mobile communication devices, and such other devices that are configured to send and receive data over network 10 in manners well known to those skilled in the art.

Advertiser devices 200 preferably include at least an advertiser website 222, which (as is known to those skilled in the art) may optionally be hosted by any third party web hosting entity, which website may include multiple web pages accessible by other parties through network 10. Advertiser devices 200 also include an electronic library of advertising content 224, which may include individual files comprising electronic advertising data that may be served through network 10 to computing devices associated with other parties, such as to provide advertisements on webpages of other parties. Such electronic advertising data preferably includes at least one of text and/or an image relating to a product or service offered by the advertiser.

Subscriber devices 220 likewise preferably include at least web browser software that enables a subscriber to access webpages on the Internet, such as advertiser websites 222, email processing software enabling a subscriber to at least receive and view email messages, and a display to display both webpages and email.

Further, publisher devices 240 preferably include at least email processing software allowing publishers to manage email campaigns in which they send electronic publications, such as newsletters, articles, alerts, and other electronic publications to subscriber devices 220 associated with subscribers of the respective publisher's email electronic publication. Alternatively or additionally, publishers may arrange to have third party email service providers manage such email campaigns through email service provider devices 260, in which case such email service provider devices 260 receive an electronic publication from a publisher device 240, and transmit such electronic publication to subscriber devices 220 of subscribers to the respective publisher's email electronic publications. Additionally, publisher devices 240 include at least communications and processing software allowing communication with advertisement management module 100, and (as discussed in greater detail below) reception of native advertisement software code from advertisement management module 100 and incorporation of such native advertisement software code into the publisher's email electronic publication prior to electronic distribution to subscriber devices 220.

The foregoing computer software implemented by advertiser devices 200, subscriber devices 220, publisher devices 240, and email service provider devices 260 are all common software applications and functions, the implementation of which is well with the level of skill of a person of ordinary skill in the art, such that they are not further detailed here.

Advertising management module 100 preferably comprises computer software that implements a native advertisement code generator 120 and an advertisement formatting engine 140, the functions of which are detailed below. Advertising management module 100 preferably includes or is in data communication with a data store 160 comprising one or more electronic publisher advertisement templates. Each electronic publisher advertisement template comprises an HTML document that defines the graphic layout of advertisements to be included in one or more email electronic publications associated with each publisher, and includes (among other data) an identification code to identify the particular publisher and/or publication, existing publisher images, Cascading Style Sheets (“CSS”), and general graphic styling.

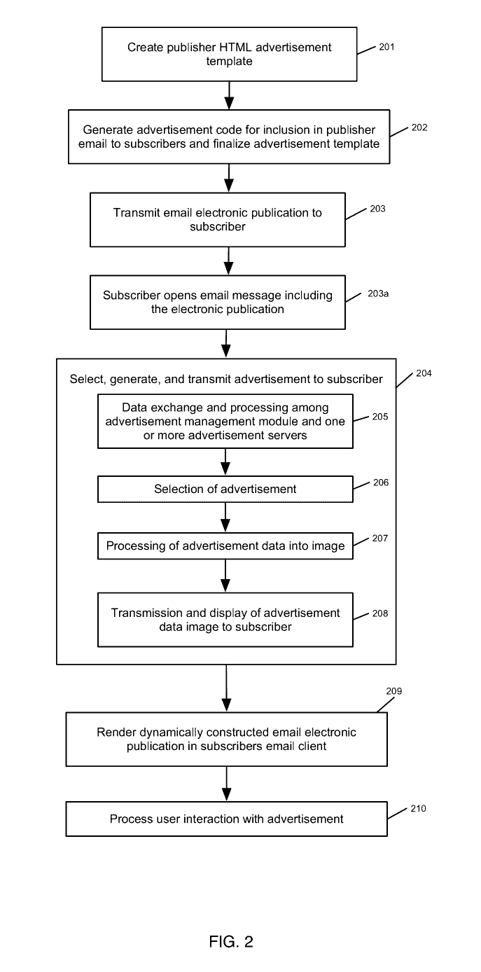

FIG. 2 is a schematic view of a method for real-time automated formatting of advertising content in email publications in accordance with certain aspects of an embodiment of the invention. At step 201, an electronic publisher advertising template is generated for a publisher associated with one of publisher devices 240. At step 202, custom advertisement code is generated and transmitted to a publisher device 240 that includes an electronic link back to advertisement management module 100, which custom advertisement code is inserted into an email electronic publication of a publisher associated with one of publisher devices 240, and the publisher advertisement template is finalized and stored in publisher advertisement template data store 160. At step 203, the email electronic publication (including the embedded custom advertisement code) is transmitted to subscribers. Thereafter, once a subscriber opens the email including the email electronic publication at step 203a, the advertisement management module 100 at step 204 selects, generates, and transmits a custom-selected advertisement to the subscriber. More particularly, at step 205, data exchange is carried out among advertisement management module 100 and one or more advertiser devices 200, at step 206 advertisement management module 100 selects an advertisement for the specific subscriber, at step 207 advertisement data received from one of advertiser devices 200 is processed into an electronic image including the advertisement data, at step 208 the electronic image including the advertisement data is transmitted to the subscriber, and at step 209 a dynamically constructed, email electronic publication is rendered in the subscriber's email client software. Finally, at step 210, advertisement management module 100 processes user interaction with the electronic image that includes the advertisement data.

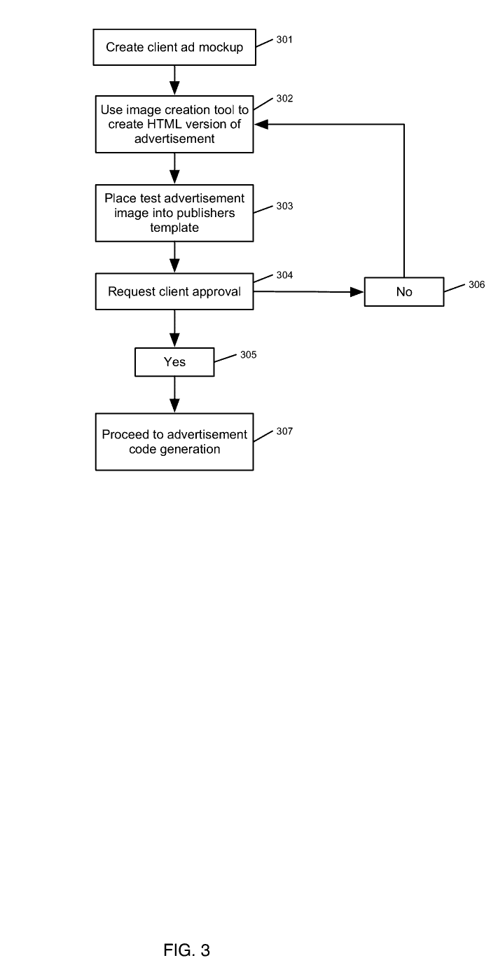

The foregoing steps of FIG. 2 are described in greater detail with reference to FIGS. 3 through 7, as follows.

FIG. 3 provides a schematic view of a method of creating an electronic publisher advertising template for a publisher associated with one of publisher devices 240 (step 201 of FIG. 2), and storing the same in publisher advertisement template data store 160. At step 301, a service provider generates a mock-up copy of what a publisher's email electronic publication will look like after syndicated advertisements, formatted as described herein, are included in such publication. Such mock-up may be created by those skilled in the art using well know electronic document publishing tools, such as ADOBE PHOTOSHOP. Once generated, the mock-up may be transmitted to the publisher for review and approval. After the publisher provides an initial approval of the mock-up, at step 302 the service provider may utilize an image creation tool to create an electronic, computer readable advertisement template, such as an HTML advertisement template based on the HTML format of the publisher's electronic publication. The HTML advertisement template may be adjusted by the service provider to adjust the appearance of advertisements that will be incorporated in such template to match the look and feel of the rest of the publication. Also at this point, the service provider may at step 303 place a static image into the template of the electronic publication and send a test through a rendering engine to test how the fully rendered email electronic publication will appear across various commercially available email clients. At step 304, the electronic publication template with the static advertisement image file may then be transmitted to the publisher or other test transmission recipient with a request for approval of the fully rendered electronic publication. If the publisher approves the appearance of the electronic publication with the advertising image (step 305), then the processing proceeds at step 307 to advertisement code generation, as discussed below. If, however, the publisher does not approve (step 306), then the process returns to step 302 to produce an alternative HTML advertising template, and then continue on through the approval process discussed above.

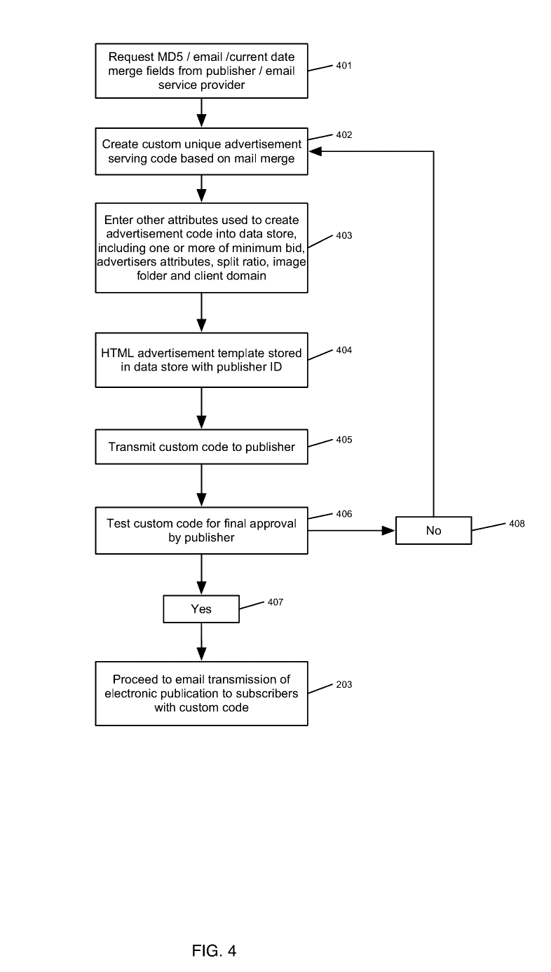

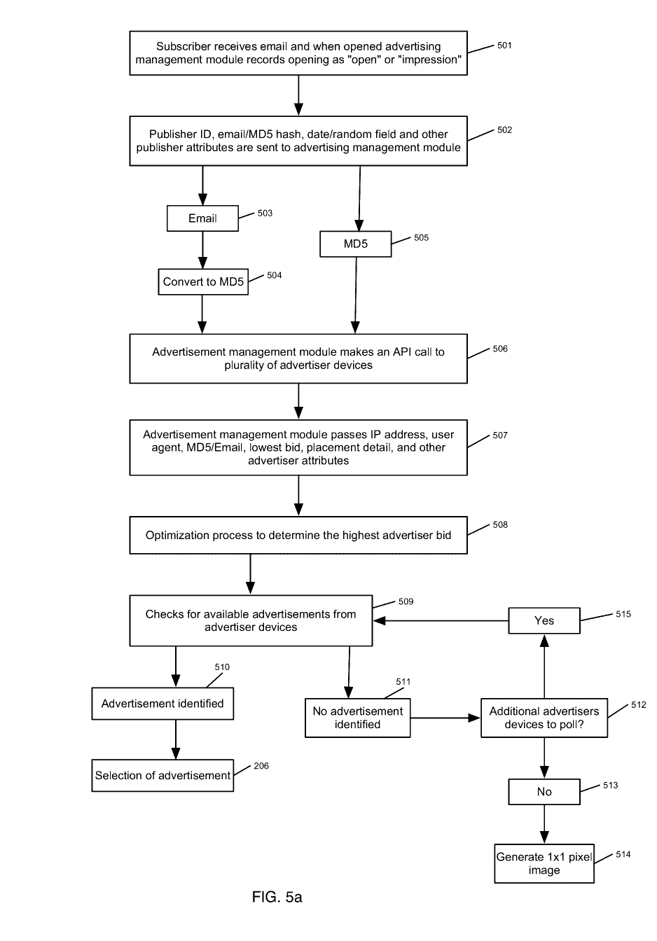

FIG. 4 provides a schematic view of a method of generating custom advertisement code, transmission of that code to a publisher device 240 that includes an electronic link back to advertisement management module 100, which custom advertisement code is inserted into an email electronic publication of a publisher associated with one of publisher devices 240, and finalizing and storage of the publisher advertisement template (including the newly generated custom advertisement code) in publisher HTML advertisement template data store 160. More particularly, following the initial creation of the publisher HTML advertising template (and with reference to FIG. 4), at step 401, native advertisement code generator 120 that is executed by advertisement management module 100 requests merge fields from publisher devices 240 and/or email service provider devices 260 (depending on which entity is managing email distribution of electronic publications on behalf of publishers associated with publisher devices 240). Those merge fields preferably include at least an MD5 hash field and email address field for including the MD5 hash and email address of each subscriber of the subject electronic publication that is to incorporate the subject HTML advertising template, a random data string and/or current date (which itself may serve as a random data string) field, and a unique identification code for the publisher. Inclusion of the random data string and/or current date field ensures that each new advertisement is seen within GOOGLE GMAIL (and hosted business addresses that rely on GMAIL as their email provider). Failure to include such random data and/or current date could result in image cache buster software preventing the advertisement from being viewed with this or similarly configured email viewing programs.

Once the merge fields have been verified, at step 402, custom ad serving code is generated based on the email merge fields obtained at step 401. The following is a representative example of code that may be provided to such publisher devices 240 and email service provider devices 260 to enable the display in real time of advertisements in electronic publications distributed by email to subscribers, which advertisements are customized for the particular subscriber:

<a target=“_blank”
href=“http://dpimpl.com/nl/?c=3456&n=1&e=%%EMAILorMD5%%”>
<img border=“0”
src=“http://dpimpl.com/ni/?c=3456&n=1&i=1&v=1&e=%%EMAILorMD5%%&r=%%
DATE%%&p=publisherpub” />
</a>

In the above code string, the following values have the noted meanings:

http://dpimpl.com—this is an exemplary domain that points back to advertisement management module 100. Those skilled in the art will recognize that any domain address may be used here that points to an advertisement management module 100 configured as set forth herein.

nl—native link (a specific URL)

ni—the value of a given advertisement (i) in a given publication (n)

c—client ID of the respective publisher

e—email/MD5

r—random field, such as the current date, to be used to avoid image caching, such as image caching tools employed by GOOGLE

i—image number

n—advertisement number

p—publication

v—version (depreciating from all new publishers)

%%MD5%%—the merge field used to produce the MD5 hash of an email address; this syntax varies depending on the email service provider

%%EMAIL%%—the merge field used to produce the raw email address; this syntax varies depending upon the email service provider

%%DATE%%—the merge field used to produce the date (e.g., 02202015) that is used to generate random text; this syntax varies depending upon the email service provider.

The above code appends an email address, or more preferably an MD5 hash, to the advertisement image and href HTML tag, as well as a date field (or other random data) to the image tag to serve as a random number to defeat image cache buster tools.

Optionally, and as shown at step 403, additional data in the form of varying publisher attributes may also be established and appended to the unique code associated with each publisher. Such additional publisher attributes may include the following:

Minimum bid—the lowest bid that is accepted on behalf of the particular publisher;

Partner attributes—this varies depending on the publisher's particular API requirements, and could be an ID or placement value that is established through the publisher's web interface or a domain to help determine the category of advertisements;

Split ratio—the split in revenue between the publisher payout and any fees payable to an administrator of advertisement management module 100;

Image folder—this determines the initial aspect ratio to use to resize an advertisement image, which may include (by way of non-limiting example) 300×300, 600×500, and 600×600, although custom and other sizes may likewise by used; and

Client domain—this is the identifiable piece referencing the domain of a publisher associated with a publisher device 240 that may be used in some cases to determine the category of advertisements to be pulled from the network of advertiser devices 200.

After the custom advertisement serving code has been generated as above, and optionally additional publisher attributes have been collected, the HTML advertisement template at step 404 is stored in data store 160 and assigned a unique publisher ID. Thereafter, at step 405, the foregoing custom advertisement serving code is sent to the designated publisher device 240 or email service provider device 260 for inclusion in the subject electronic publication, and the publisher or email service provider inserts the live advertisement serving code into their electronic newsletter template. At step 406, the publisher or email service provider may then create a final test to be deployed as a test message or a test email campaign in order to ensure that the merge fields detailed above properly populate with the intended data. If the test is successful (step 408) and the advertisement serving code is approved by the publisher, then the process continues to step 203 to email transmission of the electronic publication to subscribers with the custom advertisement serving code included in the electronic publication. As the email message is transmitted from a publisher device 240 or an email service provider device 260, the publisher ID, the email or MD5 hash, and the current data or other random data are merged into the provided advertisement serving code. If the test is not successful or the publisher for any reason objects to the function of the advertisement serving code, then at step 408 the process may return to step 402 for further refinement.

After the email publication is transmitted to subscribers at step 203 and a subscriber opens the email message including the electronic publication at step 203a, advertisement management module 100 records the opening of such message as an “open” or “impression,” and initiates step 204 of selecting, generating, and transmitting a custom-selected advertisement to the subscriber, and more specifically step 205 of data exchange among advertisement management module 100 and one or more advertiser devices 200, step 206 of selecting an advertisement for the specific subscriber, step 207 of receiving advertisement data from one of advertiser devices 200 and processing that data into an electronic image including the advertisement data, step 208 of transmitting the electronic image including the advertisement data to the subscriber, and ultimately step 209 of rendering a dynamically constructed, email electronic publication in the subscriber's email client software.

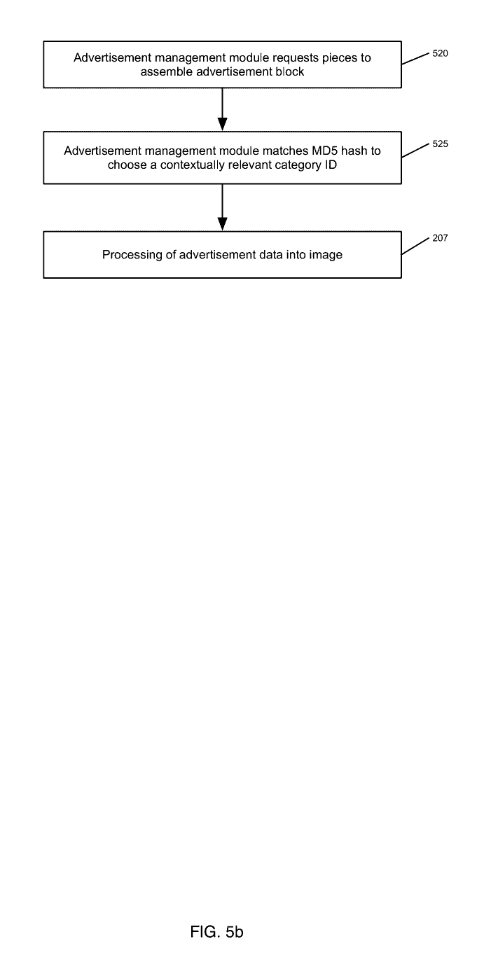

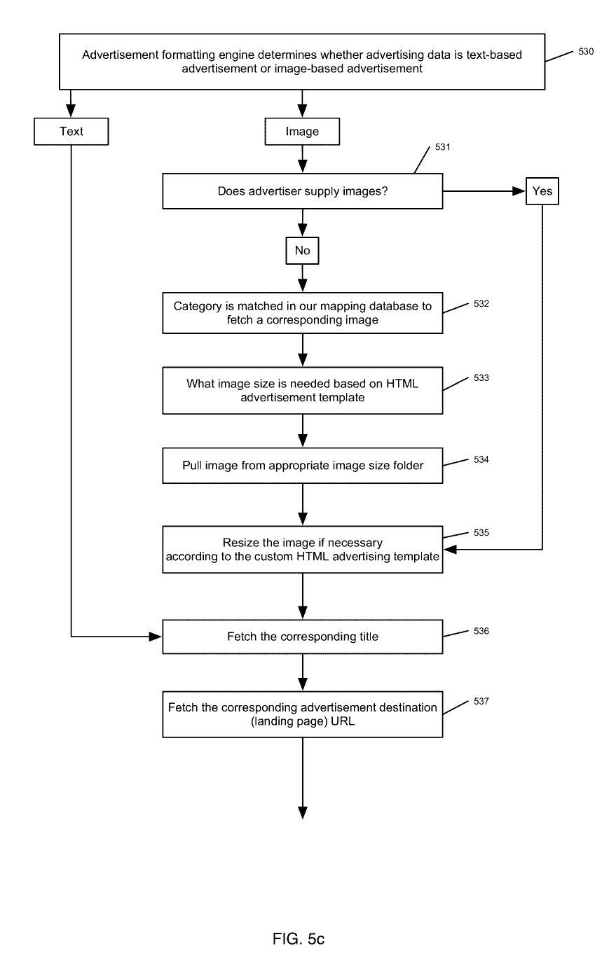

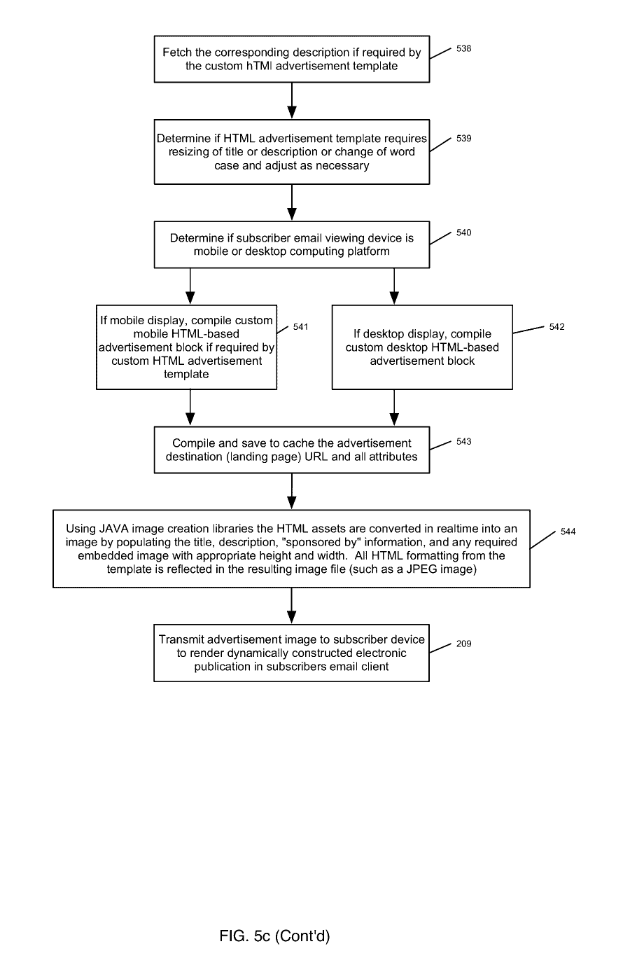

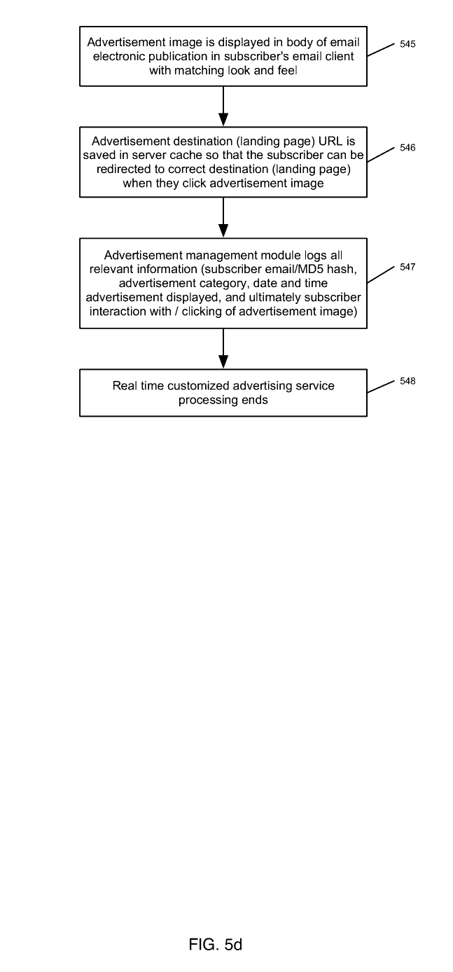

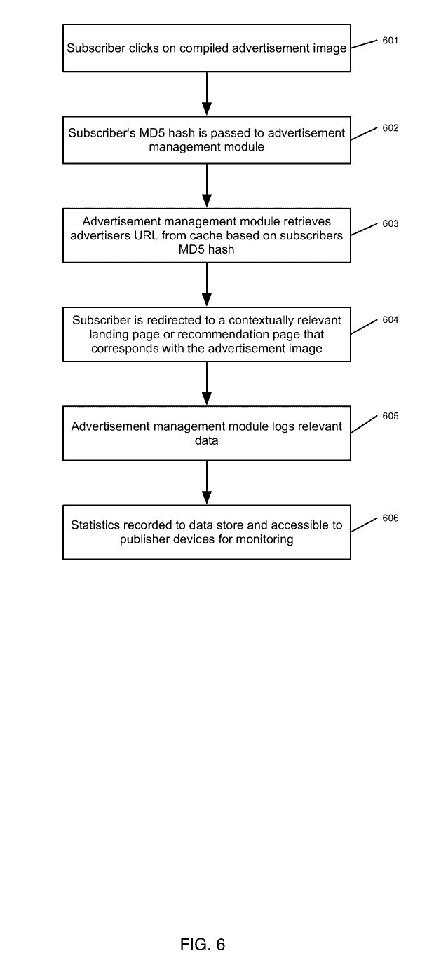

FIGS. 5a through 5d provide more detailed views of the foregoing steps 205 through 208.

FIG. 5a thus provides a schematic view of a method of data exchange and processing among advertisement management module 100 and one or more advertiser devices 200. At step 501, a subscriber of the electronic email publication receives the email message including the custom advertisement serving code, and when the subscriber opens the email, advertisement management module 100 records such opening as an “open” or “impression.” At step 502, advertisement management module 100 receives from, for example, the associated publisher device 240 or email service provider device 260 the publisher ID, email/MD5 hash, date or other random field data, and optionally other publisher attributes (as outlined above). If the respective publisher did not utilize MD5 protection, at step 503 the advertisement management module 100 reads the subscriber's email address, and at step 504 converts such email address into an MD5 hash in order to avoid passing a raw email address to advertiser devices 200. Alternatively, if the respective publisher did use MD5 protection, the advertisement management module 100 at step 505 simply maintains such MD5 hash for further processing. Next, at step 506, advertisement management module 100 makes an API call to a plurality of advertiser devices 200 in order to determine which advertisement from which advertiser device 200 will be used to display an advertisement for the particular current instance.

In order to poll the network of advertiser devices 200 to make that determination, at step 507 advertisement management module 100 passes the IP address of the particular subscriber device 220 that is associated with the subscriber that opened the email message for geographical advertisement targeting, the user agent that contains the subscriber's browser/mail client information, the MD5 hash for subscriber advertisement targeting, and preferably the lowest bid that advertisement management module 100 will accept on behalf of the particular publisher. In those instances in which an advertiser associated with an advertiser device 200 requires other attributes to be passed (including by way of non-limiting example publisher domain, publisher ID, placement/location of advertisement, etc.), such additional publisher attributes are likewise passed to those advertiser devices 200 that require them.

With continued reference to FIG. 5a, at step 508 advertisement management module 100 may initiate an optimization process to determine the highest advertiser bid, which advertisement management module 100 may use as an additional factor in determining what advertisement to present to the subscriber. The optimization process may be carried out through a waterfall, a bidding process, or a combination of the foregoing. At step 509, employing such optimization process, advertisement management module 100 makes an API call to a selected advertiser device 200 to determine if such advertiser device 200 can supply one or more advertisements meeting current criteria. If such API call is successful then the advertisement device 200 is selected as a source of one or more available advertisements at step 510, and the process proceeds to step 206 of selection of the advertisement. If such API call is unsuccessful, then at step 511 advertisement management module 100 determines that a suitable advertiser device has not been identified, and determines at step 512 whether additional advertiser devices 200 are available to poll. If so, at step 515 advertisement management module returns to step 509 to continue to check for suitable advertiser devices. If advertisement management module 100 determines, however, that there are no additional advertiser devices 200 available to poll at step 513, then advertisement management module 100 may generate a 1×1 pixel image at step 514, which will then comprise the image presented in the email electronic publication. Such 1×1 pixel will be transparent to the subscriber in the electronic newsletter, and ensures that when no advertisement is selected, the electronic newsletter template will not be degraded in any way.

Next, FIG. 5b provides a schematic view of a method of selection of an advertisement in accordance with step 206 after a suitable advertiser device 200 has been selected. At step 520, advertisement management module 100 makes an API call to the selected advertiser device 200 to request the necessary pieces to make up the advertisement unit. In requesting those pieces, advertisement management module at step 525 preferably matches the subscriber's MD5 hash to choose a contextually relevant category ID from advertisement data contained in advertiser content 224, using ad-matching techniques well known to those skilled in the art. Having identified a particular advertisement having a contextually relevant category ID, the advertisement data associated with such advertisement is then processed in accord with step 207.

FIG. 5c provides a schematic view further detailing the method of step 207 of processing advertisement data into an image for inclusion in the email electronic publication. At step 530, advertisement management module executes advertisement formatting engine 140 to determine whether the received advertisement data is a text-based advertisement or an image-based advertisement. If the determination is made that the advertisement data requires an advertisement that is text only (such that it does not require an image), text will be copied from the advertisement data and put into a format in accordance with the HTML advertisement template, from which an image of only the text will be generated for display in the email electronic publication, all as detailed further below. If the determination is made that the advertisement data requires an advertisement that includes an image, then advertisement formatting engine 140 determines at step 531 whether the image is available from advertiser device 200 that provided such advertisement data. If the image is available from such advertiser device 200, then advertisement formatting engine 140 proceeds to step 535 of resizing the received image if and as necessary to match the image size requirement set forth in the custom HTML advertisement template. Likewise, if the image for the advertisement is not available from such advertiser device 200, then at step 532, in real time the advertisement data category ID is matched by advertisement formatting engine 140 to fetch the correct image from an electronic library of images to create the advertisement. Optionally, such electronic library may also be stored in data store 160. Then, at step 533, advertisement formatting engine 140 determines what image size is required based on the HTML advertisement template in data store 160 for the particular electronic publication that has been emailed to subscriber device 220. In certain embodiments, such images may be available in a variety of image sizes, such as (by way of non-limiting example) 300×300 pixels, 600×500 pixels, 600×600 pixels, and custom sizes outside of the foregoing. If for any reason the size of the image obtained from the electronic library of images does not match the size requirement set forth in the HTML advertisement template, at step 535 such image may be resized as described above for an advertiser-supplied image.

Once any required image has been obtained and properly sized, or immediately following identification of the advertisement as text-only, at step 536 advertisement formatting engine 140 makes an API call to the respective advertiser device 200 to pass the corresponding title for the advertisement, and at step 537 makes an API call to the same respective advertiser 200 to pass the corresponding advertisement destination (landing page) URL, which may include, by way of non-limiting example, advertiser website 222. Likewise, at step 538, advertisement formatting engine 140 makes an API call to the same respective advertiser 200 to pass any corresponding description for the advertisement. In certain cases the custom HTML advertisement template may not require any advertisement description, in which case any description received by advertisement formatting engine 140 will simply not be displayed in the email electronic publication.

Next, at step 539, advertisement formatting engine 140 compares the format of the received title and description to the HTML advertisement template to determine whether the number of characters in the title and/or description should be modified to meet any pre-established limit set forth in the template (e.g., where advertisement space is limited in the email electronic publication), and likewise whether the letter case of any words in the title or description should be modified (e.g., to all caps) to meet any pre-established rule for letter case set forth in the template (e.g., to ensure that the flow of the email electronic publication is not disrupted). If such adjustments are required, advertisement formatting engine 140 adjusts the title and description as necessary to meet such requirements.

At step 540, advertisement formatting engine 140 determines whether the subscriber device 220 on which they are viewing email is a mobile or a desktop computing platform, to in turn determine whether the advertisement image that is to be rendered will require display on a mobile display or a desktop display. In certain instances, there may be no difference in the appearance of the advertisement image from the mobile display to the desktop display, but in other instances significant differences might be necessary in order to ensure that the advertisement image displays properly. If advertisement formatting engine 140 determines that the subscriber device is a mobile device, then at step 541 advertisement formatting engine 140 queries the HTML advertisement template to determine if a mobile advertisement block template is included and associated with the respective publisher's ID, and if so, such mobile advertisement block template is loaded from data store 160. Likewise, if advertisement formatting engine 140 determines that the subscriber device is a desktop device, or if no mobile advertisement block template is associated with the respective publisher's ID, then at step 542 advertisement formatting engine 140 loads the desktop advertisement block template from data store 160. Thereafter, at step 543, all attributes that were pulled from the API and data store 160, along with the advertisement destination, are compiled and saved to a cache of advertisement management module 100. Finally, at step 544, using JAVA image creation libraries, advertisement formatting engine 140 converts the HTML assets in real time into an image by populating the title, description, “sponsored by” information, and any required embedded image with the appropriate height and width. All HTML formatting from the advertisement template is reflected in the resulting image file (such as a JPEG image). Each advertisement image is assembled based on the customized advertisement selection process discussed above and derived from the publisher's subscriber's email/MD5 hash. Once the image file is created, the advertisement is ready for display, such that at step 209 the advertisement image is transmitted to the subscriber device 220, and the fully rendered, dynamically constructed, email electronic publication, including the custom advertisement image, is configured for display in the subscriber's email client.

FIG. 5d provides a schematic view further detailing the method of step 209 of transmitting the advertisement image to the subscriber device 220, with the fully rendered, dynamically constructed, email electronic publication, including the custom advertisement image, configured for display in the subscriber's email client. At step 545, the advertisement image is displayed in the body of the email electronic publication in the subscriber's email client, having the same look and feel as the rest of the email electronic publication. Preferably simultaneously, at step 546 the advertisement destination (i.e., the landing page) URL is saved in a cache of advertisement management module 100 so that the subscriber can be redirected to the correct destination (landing page) when they click the advertisement image. Also preferably simultaneously, at step 547 advertisement management module 100 logs all relevant information, including preferably at least the subscriber email/MD5 hash, the advertisement category, the date and time at which the advertisement image was displayed on the subject subscriber device 220, and ultimately any subscriber interaction with the advertisement image, such as clicking on the image. Finally, at step 548, the real time customized advertisement service processing ends, but advertisement management module 100 continues to monitor for user interaction with the advertising image.

Advertisement management module 100 is preferably configured to use serialized caching (i.e., if a server on which advertisement management module 100 is running shuts down, all information is written to a flat file, and when such server starts back up, the information is restored from the flat file and placed into the new cache), which ensures that the advertisement for each unique publisher is always available. This also ensures that each publisher's data is kept separate for reporting and accounting purposes.

FIG. 6 provides a schematic view of the method of step 210 of processing user interaction with the advertisement image. At step 601, the subscriber clicks on the advertisement image that has been formatted to match the look and feel of the electronic publication that has been emailed to the subscriber. At step 602, the advertisement management module 100 receives from the respective subscriber device 220 the MD5 hash associated with the subscriber. At step 603, advertisement management module 100 retrieves from its cache the URL of the advertiser website 222 based on the subscriber's MD5 hash. At step 604, advertisement management module 100 then redirects the subscriber (via an Internet browser executing on subscriber device 220) to a contextually relevant landing page or recommendation page that corresponds with the advertisement image. At step 605, advertisement management module 100 logs all relevant data. Such data may include, by way of non-limiting example, information regarding the API calls (i.e., connections with advertiser devices 200), and particularly all information passed from advertiser device 200, such as advertisement categories, MD5 hash, bid value, advertiser's name, URL of advertiser website 222, user agent information, IP address of subscriber device 220, device type (i.e., the type of device (mobile, tablet, desktop) on which the advertisement was displayed), and any information passed from publisher device 240. Likewise, all click, impressions, and payout statistics are recorded by advertisement management module 100. Finally, at step 606 statistics (e.g., counts of clicks, opens, final bid amount, reports of bad IP addresses, date/time stamp, advertisement category, etc.) are recorded to data store 160 and made available to publisher devices 240 for further monitoring and analysis of their subscriber's interaction with their email electronic publications.

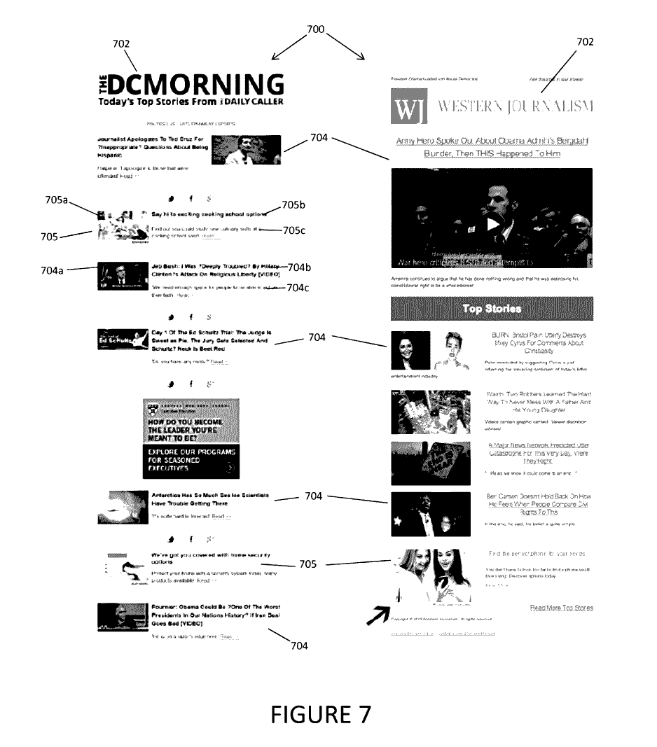

FIG. 7 provides exemplary representations of fully rendered, dynamically constructed, email electronic publications created and distributed using the system and in accordance with the methods described above. Each such email electronic publication includes a unique, definable “look and feel” that creates a unique visual impression. For instance, with respect to each of the representative publications 700 shown in FIG. 7, the look and feel generally includes a header 702 with the title of the publication, followed by a series of separate items, each of which is presented as a separate article 704 of the publication. Each such article 704 in this particular exemplary email electronic publication includes a graphic image 704a on the left side of the entry, a bold title 704b for the entry, and a brief text description 704c of the article beneath the bold title. In addition to such articles, the email electronic publication (formatted in accordance with certain aspects of an embodiment of the invention) also includes one or more advertisements 705 which share a common look and feel with the articles. Specifically, each such advertisement 705 includes a graphic image 705a on the left side of the entry, a bold title 705b for the entry, and a brief text description 705c of the advertisement beneath the bold title. This presents the advertisement in such a way that the publication's subscriber views it in an initial visual scan of the email electronic publication as no different from the remaining content in the publication, thus increasing the likelihood that they will spend equal time reviewing the advertisement as they spend in reviewing the publication content, and in turn increasing the likelihood that they will engage with such advertisement.

By employing the system and methods set forth above to provide subscriber-specific, publication-customized advertising content in real-time, the system and methods described herein accept raw advertising assets (e.g., text and images) directly from advertisers, agencies, or third party networks via API feeds, web interface, or other manual and automated methods as are known to those of ordinary skill in the art. The raw advertising assets are then automatically, in real-time, formatted according to the native look and feel of the publication in which they are to be presented by email to subscribers, using a preformatted custom HTML template. This process results in a “native advertisement” (i.e., an advertisement with the same look and feel as the editorial or other content) in the email electronic publication. A digital image of the advertisement is then automatically generated in real-time and inserted into the email electronic publication for display with the rest of the content of the publication in the subscriber's native email client. Advertisement targeting logic based on an encrypted version of a subscriber's email address (preferably using, e.g., the MD5 message-digest algorithm to generate a cryptographic hash function to mask the subscribers' email addresses, as known to those of ordinary skill in the art) that is subscribed to the email publication is then used. Because of the real-time nature of this process, along with the customized HTML conversion, the result is a seamless advertising image natively displayed in the email electronic publication.

Each of the computing devices described herein may be implemented in digital electronic circuitry, or in computer software, firmware, or hardware. Moreover, the computer software functions described herein may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described herein may be implemented as operations performed by a data processing apparatus on data stored on one or more computer-readable storage devices or received from other sources.

The device on which advertisement management module 100 executes, along with advertiser devices 200, subscriber devices 220, publisher devices 240, and email service provider devices 260, may include personal computers and server/client computing architecture, including a variety of devices configured for processing data, such as (by way of non-limiting example) a programmable processor, a computer, a system on a chip, or multiple ones or combinations of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of the foregoing). The apparatus and execution environment may realize various different computing model infrastructures, such as web services, distributed computing and grid computing infrastructures.

A computer program, software, application, script, or code described herein may be written in any form of programming language, including compiled or interpreted languages, declarative or procedural languages, and it may be deployed in any form, including as a stand-alone program or as a module, component, subroutine, object, or other unit suitable for use in a computing environment. A computer program may optionally correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of non-limiting example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer may also include, or be operatively coupled to receive data from or transfer data to, or both, one or more mass storage devices for storing data (e.g., magnetic, magneto-optical disks, or optical disks). A computer may also be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive, etc.). Devices suitable for storing computer program instructions and data include all forms of non-volatile memory, media and memory devices, including by way of non-limiting example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

Any of the foregoing computing devices may include numerous devices for user interaction, including by way of non-limiting example a display device (e.g., CRT (cathode ray tube), LCD (liquid crystal display), OLED (organic light emitting diode), TFT (thin-film transistor), or other flexible configuration, or any other monitor for displaying information to the user and a keyboard), a pointing device (e.g., a mouse, trackball, touch screen, touch pad, etc.) by which the user may provide input to the computer, sensory feedback devices (e.g., visual feedback, auditory feedback, or tactile feedback), and input devices allowing user input by speech, acoustic, or tactile input. Further, the foregoing computing devices may send documents to and receive documents from a user device, including by way of non-limiting example by sending web pages to a web browser on a user's client device in response to requests received from the web browser.

Still further, implementations of the subject matter set forth herein may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter set forth herein, or any combination of one or more of such back-end, middleware, or front-end components. The components of the system may be interconnected by any form or medium of digital data communication (e.g., a communication network), including by way of non-limiting example a LAN or WAN, an inter-network (e.g., the Internet), and peer-to-peer networks (e.g., ad hoc peer-to-peer networks).

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. For example, although certain process flows and displays have been shown, the particular components of each flow and display may be rearranged as appropriate, and additional components may be added, or components may be combined, separated, or eliminated, as appropriate. It should be understood, therefore, that the invention may be practiced otherwise than as specifically set forth herein.

1. A computer-implemented method for presenting to a subscriber a composite email electronic publication having non-advertising data with a defined look and feel and advertising data, the method comprising:
providing a computer system including a computer processor having computer executable code configured to execute an advertisement management module;
creating at said advertisement management module and storing in memory a computer readable advertisement template including a publisher identification and defining a look and feel matching a look and feel of said non-advertising data in said email electronic publication;
receiving at said advertisement management module notification from a subscriber computing device that an email message including an email electronic publication has been opened on said subscriber computing device;
receiving at said advertisement management module advertisement data from an advertiser computing device;
in response to receiving said notification from a subscriber computing device, retrieving said advertisement template based on said publisher identification and creating at said advertisement management module an electronic image including said advertisement data, wherein said electronic image is automatically formatted with a visual appearance defined by said advertisement template; and
transmitting said electronic image to said subscriber computing device, wherein the transmission is configured to cause a dynamically constructed email electronic publication including an advertisement having a look and feel matching non-advertising content of said email electronic publication to be rendered in email client software on said subscriber device.

2. The method of claim 1, wherein said advertisement data is custom selected for a subscriber associated with said subscriber computing device.

3. The method of claim 2, wherein said advertisement data is selected after said step of receiving at said advertisement management module notification from a subscriber computing device that an email message including an email electronic publication has been opened on said subscriber computing device.

4. The method of claim 1, wherein said advertisement data comprises at least text data, and wherein said electronic image comprises an electronic image of at least said text data.

5. The method of claim 1, further comprising the step of generating at said advertisement management module publisher-specific computer code configured to:
merge email address identifiers of subscribers of said electronic publication, a random data string, and said publisher identification into said code;
transmit, upon opening of an email by a subscriber, said publisher identification, an email address identifier of an individual subscriber, and said random data string to said advertising management module; and
and to receive and display at said subscriber computing device said electronic image in said email electronic publication.

6. The method of claim 5, wherein said publisher-specific computer code is configured for insertion into said email electronic publication and for execution upon opening of said email message including said email electronic publication.

7. The method of claim 6, further comprising the step of transmitting from said advertisement management module said publisher-specific computer code to a publisher computing device prior to transmission of said email electronic publication to said subscriber computing device.

8. A system for presenting to a subscriber a composite email electronic publication having non-advertising data with a defined look and feel and advertising data, comprising:
a memory;
a database;
a computer processor coupled to the memory and the database, the processor having computer executable code configured to execute an advertisement management module, wherein said computer executable code is further configured to:
create and store in said memory a computer readable advertisement template including a publisher identification and defining a look and feel matching said look and feel of said non-advertising data in said email electronic publication;
receive at said advertisement management module notification from a subscriber computing device that an email message including an email electronic publication has been opened on said subscriber computing device;
receive at said advertisement management module advertisement data from an advertiser computing device;
in response to receiving said notification from a subscriber computing device, retrieving said advertisement template based on said publisher identification and create at said advertisement management module an electronic image including said advertisement data, wherein said electronic image is automatically formatted with a visual appearance defined by said advertisement template; and
transmit said electronic image to said subscriber computing device, wherein the transmission is configured to cause a dynamically constructed email electronic publication including an advertisement having a look and feel matching non-advertising content of said email electronic publication to be rendered in email client software on said subscriber device.
a transmission device configured to transmit the electronic image to a subscriber by email.

9. The system of claim 8, wherein said advertisement data is custom selected for a subscriber associated with said subscriber computing device.

10. The system of claim 9, wherein said computer executable code is further configured to select said advertisement data after receiving at said advertisement management module notification from a subscriber computing device that an email message including an email electronic publication has been opened on said subscriber computing device.

11. The system of claim 8, wherein said advertisement data comprises at least text data, and wherein said electronic image comprises an electronic image of at least said text data.

12. The system of claim 8, wherein said computer executable code is further configured to generate at said advertisement management module publisher-specific computer code configured to:
merge email address identifiers of subscribers of said electronic publication, a random data string, and said publisher identification into said code;
transmit, upon opening of an email by a subscriber, said publisher identification, an email address identifier of an individual subscriber, and said random data string to said advertising management module; and
receive and display at said subscriber computing device said electronic image in said email electronic publication.

13. The system of claim 12, wherein said publisher-specific computer code is configured for insertion into said email electronic publication and for execution upon opening of said email message including said email electronic publication.

14. The system of claim 13, wherein said executable code is further configured to transmit from said advertisement management module said publisher-specific computer code to a publisher computing device prior to transmission of said email electronic publication to said subscriber computing device.

15. A non-transitory computer-readable storage medium storing instructions for causing a processor to perform a method for presenting to a subscriber a composite email electronic publication having non-advertising data with a defined look-and-feel and advertising data, the method comprising the steps performed by the processor of:
executing an advertisement management module;
creating at said advertisement management module and storing in memory a computer readable advertisement template including a publisher identification and defining a look and feel matching a look and feel of said non-advertising data in said email electronic publication;
receiving at said advertisement management module notification from a subscriber computing device that an email message including an email electronic publication has been opened on said subscriber computing device;
receiving at said advertisement management module advertisement data from an advertiser computing device;
in response to receiving said notification from a subscriber computing device, retrieving said advertisement template based on said publisher identification and creating at said advertisement management module an electronic image including said advertisement data, wherein said electronic image is automatically formatted with a visual appearance defined by said advertisement template; and
transmitting said electronic image to said subscriber computing device, wherein the transmission is configured to cause a dynamically constructed email electronic publication including an advertisement having a look and feel matching non-advertising content of said email electronic publication to be rendered in email client software on said subscriber device.

16. The non-transitory computer-readable storage medium of claim 15, wherein said advertisement data is custom selected for a subscriber associated with said subscriber computing device.

17. The non-transitory computer-readable storage medium of claim 16, wherein said advertisement data is selected after said step of receiving at said advertisement management module notification from a subscriber computing device that an email message including an email electronic publication has been opened on said subscriber computing device.

18. The non-transitory computer-readable storage medium of claim 15, wherein said advertisement data comprises at least text data, and wherein said electronic image comprises an electronic image of at least said text data.

19. The non-transitory computer-readable storage medium of claim 15, further comprising instructions for causing said processor to generate at said advertisement management module publisher-specific computer code configured to:
merge email address identifiers of subscribers of said electronic publication, a random data string, and said publisher identification into said code;
transmit, upon opening of an email by a subscriber, said publisher identification, an email address identifier of an individual subscriber, and said random data string to said advertising management module; and
receive and display at said subscriber computing device said electronic image in said email electronic publication.

20. The non-transitory computer-readable storage medium of claim 19, wherein said publisher-specific computer code is configured for insertion into said email electronic publication and for execution upon opening of said email message including said email electronic publication.

21. The non-transitory computer-readable storage medium of claim 20, further comprising instructions for causing said processor to transmit from said advertisement management module said publisher-specific computer code to a publisher computing device prior to transmission of said email electronic publication to said subscriber computing device.
